(19) United States
(12) Patent Application Publication
(10) Pub. No.: US 2025/0059102 A1
(43) Pub. Date: Feb. 20, 2025

(54) Refractory Coating

(71) Applicant: VIBRANTZ MINERALS LIMITED, Staffordshire (GB)

(72) Inventors: Philip Frampton, Staffordshire (GB); Michal Miekina, Staffordshire (GB)

(21) Appl. No.: 18/723,373

(22) PCT Filed: Dec. 23, 2022
(86) PCT No.: PCT/GB22/53387

§ 371 Date: Jun. 21, 2024

(30) Foreign Application Priority Data
Dec. 23, 2021 (GB) 2118967.5

(51) Int. Cl. C04B 41/50; C03C 8/22; C04B 41/00; C04B 41/52

(52) U.S. Cl. CPC C04B 41/5022; C03C 8/22; C04B 41/009; C04B 41/52

(57) ABSTRACT

A composition for coating a refractory body. The composition comprises; an oxidizable component; and a phosphate frit comprising phosphorous oxide. The composition is substantially aluminum metal free.

### CROSS-REFERENCE TO RELATED APPLICATIONS

This application is a US national stage entry of International Patent Application No. PCT/GB22/53387, filed Dec. 23, 2022, which claims priority to GB2118967.5, filed Dec. 23, 2021, the entire contents of which are incorporated by reference herein.

### TECHNOLOGICAL FIELD

Embodiments of the present disclosure relate to a coating for a refractory. Some relate to a coating for a carbon-based refractory.

### BACKGROUND

Carbon based refractories, such as MgO—C, Al₂O₃—C, ZrO₂—C, or graphite, are used in the continuous metal casting industry. The refractory can be used to form for instance submerged entry nozzles, pouring nozzles, ladle shrouds and monoblock stoppers. The refractories operate at temperatures of up to 1200-1600° C., depending on the location in the continuous casting process. It is known that the carbon in the refractory protects the refractory from attack or erosion by molten steel, molten alloys, and slags.

When the refractory is not submerged in metal, the carbon in the refractory can oxidize, thereby losing carbon from the refractory and potentially causing an early failure of the refractory. It is therefore desirable to apply a coating (otherwise known as a glaze) to the refractory, to inhibit oxidation of the carbon and prolong the life of the refractory.

Known coatings for carbon-based refractories do provide some protection, but it is desirable to increase the level of protection provided by the coating.

### BRIEF SUMMARY

According to various, but not necessarily all, embodiments there is provided a composition for coating a refractory body, the composition comprising: an oxidizable component; and a phosphate frit comprising phosphorous oxide, wherein the composition is substantially aluminum metal free.

The composition may comprise up to 90 wt. % of the phosphate frit. The composition may comprise up to 30 wt. % of the phosphate frit. The composition may comprise 2 to 90 wt. % of the phosphate frit. The composition may comprise 2 to 9 wt. % of the phosphate frit. The composition may comprise 60 to 90 wt. % of the phosphate frit.

The phosphate frit may comprise 30 to 70 wt. % of phosphorous oxide. The phosphate frit may comprise up to 50 wt. % aluminum oxide. The phosphate frit may be substantially free of silicon oxide. The phosphate frit may comprise 5 to 35 wt. % sodium oxide. The phosphate frit may comprise 0 to 5 wt. % of boron oxide. The phosphate frit may comprise up to 6 wt. % of boron oxide.

The composition may comprise a glass frit, different from the phosphate frit. The glass frit may be a glass frit component. The composition may comprise 5 to 70 wt. % of the glass frit. The glass frit may comprise a silicate frit. The silicate glass frit may comprise a borosilicate frit.

The glass frit may comprise a borosilicate frit and a boron-free silicate frit. The composition may comprise 5 to 50 wt. % of the borosilicate frit and 1 to 20 wt. % of the boron-free silicate frit. The glass frit may comprise the borosilicate frit and a different, cobalt-containing, borosilicate frit. The composition may comprise 30 to 50 wt. % of the borosilicate frit and 10 to 20 wt. % of the different, cobalt-containing, borosilicate frit.

The composition may further comprise a refractory component. The composition may comprise 2 to 20 wt. % of the refractory component. The refractory component may comprise clay.

The composition may comprise 2 to 40 wt. % of the oxidizable component.

The oxidizable component may comprise a metal or metalloid. The composition may comprise 2 to 25 wt. % of the metal or metalloid. The metal or metalloid may comprise silicon metalloid.

The oxidizable component may comprise a carbide. The composition may comprise 1 to 15 wt. % of the carbide. The carbide may comprise silicon carbide.

The composition may be in powder form.

According to various, but not necessarily all, embodiments there is provided a slurry for coating a refractory body, the slurry comprising a liquid, and the composition of any of the preceding paragraphs suspended in the liquid.

According to various, but not necessarily all, embodiments there is provided a carbon-based refractory body coated with the composition of any of the preceding paragraphs.

According to various, but not necessarily all, embodiments there is provided a method of coating a refractory body, comprising applying the slurry of any of the preceding paragraphs to the refractory body.

The method may further comprise allowing the slurry to dry, then applying more of the slurry to the refractory body, to provide a further coating of the composition on the refractory body.

According to various, but not necessarily all, embodiments there is provided a refractory body coating comprising: an oxidizable component; and a phosphate frit comprising phosphorous oxide, wherein the composition is substantially aluminum metal free.

The refractory body coating includes at least a first layer and a second layer, the first layer is substantially aluminum free and comprises the oxidizable component and the phosphate frit, and the second layer is substantially aluminum free and comprises a further oxidizable component and a further phosphate frit comprising phosphorous oxide.

The first layer may comprise up to 30 wt. % of the phosphate frit. The first layer may comprise 2 to 9 wt. % of the phosphate frit. The first layer may comprise a glass frit. The second layer may comprise 60 to 90 wt. % of the phosphate frit. The second layer may provide an exterior surface of the refractory body coating.

According to various, but not necessarily all, embodiments there is provided a carbon-based refractory body coated with the refractory body coating of any of the preceding paragraphs to the refractory body coating. At least part of the first layer of the refractory body coating may be located between a surface of the carbon-based refractory body and the second layer.

According to various, but not necessarily all, embodiments there is provided examples as claimed in the appended claims.

### BRIEF DESCRIPTION

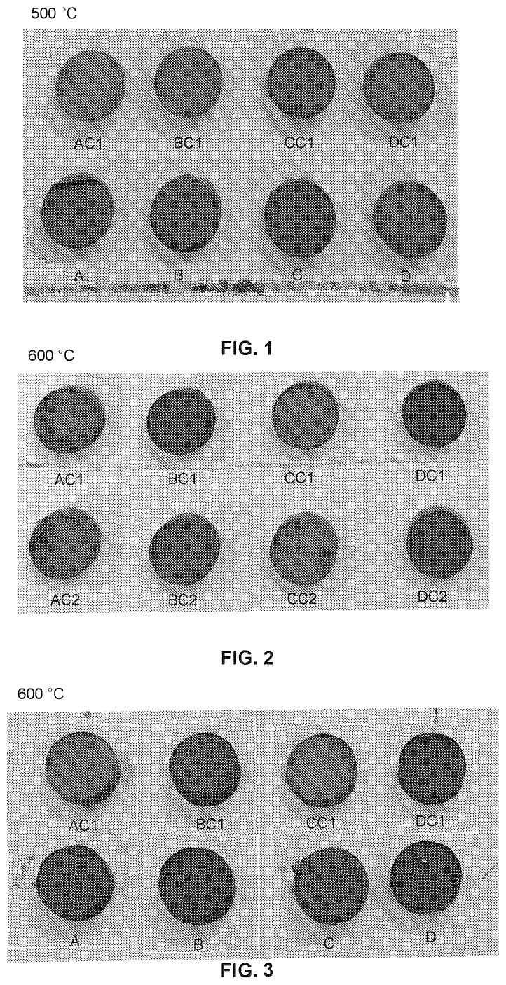

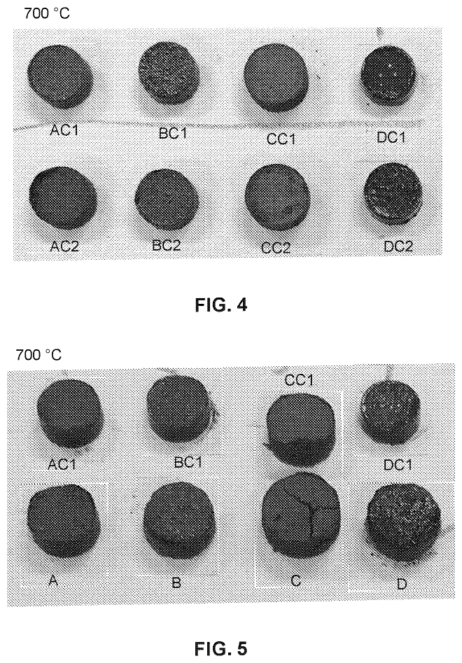

FIGS. 1 to 9 illustrate the results of testing on examples A, B, C and D of the disclosure and comparative examples.

For a better understanding of various examples that are useful for understanding the detailed description, reference will now be made by way of example only.

### DETAILED DESCRIPTION

Examples of the disclosure provide a composition for coating a refractory body, the composition comprising: an oxidizable component; and a phosphate frit comprising phosphorous oxide, wherein the composition is substantially aluminum metal free.

It is to be appreciated that a frit is at least partially amorphous, and therefore a reference to an “oxide” does not necessarily imply that the oxide is present in stoichiometric crystalline form in the frit. For example, a reference to aluminum oxide or Al₂O₃ being present in the frit does imply that aluminum and oxide ions are present in the frit, which could for instance be in an amorphous mixed metal oxide. The amorphous mixed metal oxide may for instance also include halide ions. Thus, a reference to, for example, aluminum oxide or Al₂O₃ being present in the frit does not necessarily imply that crystalline Al₂O₃ is present in the frit.

Table 1 below provides examples of the disclosure A, B, C, D, E, F and G along with comparative examples AC1, AC2, BC1, BC2, CC1, CC2, DC1 and DC2.

TABLE 1

| | Example - | | | | | | | | | | | | | | |
|---|---|---|---|---|---|---|---|---|---|---|---|---|---|---|---|
| | A/ | AC1/ | AC2/ | B/ | BC1/ | BC2/ | C/ | CC1/ | CC2/ | D/ | DC1/ | DC2/ | E/ | F/ | G/ |
| | wt. % | wt. % | wt. % | wt. % | wt. % | wt. % | wt. % | wt. % | wt. % | wt. % | wt. % | wt. % | wt. % | wt. % | Wt. % |
| Silicate Frits | 53 | 56 | 53 | 52 | 55 | 52 | 53 | 56 | 53 | 55 | 58 | 55 | 59 | 11 | 0 |
| Clay | 8 | 9 | 8 | 3 | 3 | 3 | 10 | 11 | 10 | 9 | 10 | 9 | 10 | 2 | 0 |
| Carbide | 8 | 9 | 8 | 11 | 12 | 11 | 0 | 0 | 0 | 9 | 10 | 9 | 10 | 2 | 10 |
| Metal/ | 20 | 21 | 20 | 22 | 23 | 22 | 31 | 33 | 31 | 21 | 22 | 21 | 19 | 4 | 0 |
| Metalloid | | | | | | | | | | | | | | | |
| Refractory | 5 | 5 | 5 | 7 | 7 | 7 | 0 | 0 | 0 | 0 | 0 | 0 | 0 | 0 | 0 |
| Oxide | | | | | | | | | | | | | | | |
| Phosphate | 6 | 0 | 0 | 5 | 0 | 0 | 6 | 0 | 0 | 6 | 0 | 0 | 2 | 76 | 85 |
| Frit | | | | | | | | | | | | | | | |
| Bentonite | 0 | 0 | 6 | 0 | 0 | 6 | 0 | 0 | 6 | 0 | 0 | 6 | 0 | 5 | 5 |
| Clay | | | | | | | | | | | | | | | |

The example compositions A, B, C, D, E, F and G of Table 1 are for coating a carbon-based refractory body, and each comprises an oxidizable component and a phosphate frit. Example compositions A-F each comprise a glass frit; no such glass frit is present in example composition G. In each of example compositions A-F, the glass frit comprises two silicate frits and the oxidizable component comprises a carbide or a metalloid or both a carbide and a metalloid.

All of the examples of Table 1 are also advantageously substantially aluminum metal free. Aluminum metal and aluminum metal alloys can react with water to evolve hydrogen, which can impede the preparation of the coating and produce holes in the coating.

In some instances, one of the compositions A-E may be used to form a single layer coating on a carbon-based refractory body. That is, the coating consists of a single layer.

One of the example compositions A-E may be used to form a layer in a multi-layer coating on a carbon-based refractory body and another layer may be formed from one of the example compositions F or G. The layer formed by any one of example compositions A-E may be considered to be a first layer and otherwise referred to as the “main layer” and the layer formed by either of example compositions F or G may be considered to be a second layer and otherwise referred to as the “top layer”.

In a multi-layer coating, the phosphate frit in each layer may be the same or different. The oxidizable component in each layer may be the same or different. The top layer may provide an exterior surface of the coating and at least part of the main layer of the coating may be located between a surface of the carbon-based refractory body and the top layer.

The first set of comparative examples AC1, BC1, CC1, and DC1 in Table 1 are the same as examples A, B, C, and D respectively, but AC1, BC1, CC1, and DC1 do not include a phosphate frit, and the relative amounts of the other components of AC1, BC1, CC1, and DC1 have been increased accordingly relative to examples A, B, C, and D. The second set of comparative examples AC2, BC2, CC2, and DC2 in Table 1 are the same as examples A, B, C, and D respectively, but the phosphate frit of examples A, B, C, and D has been directly substituted with bentonite clay, at the same weight percentage as the phosphate frit.

It has been advantageously found that example compositions with the phosphate frit provide significantly improved performance as a refractory coating, relative to known coatings. Without being bound by theory, it is believed that the known refractory coatings protect the carbon-based refractory well from high temperature (e.g., over 800° C.) carbon burnout. Carbon burnout is the oxidation of carbon within the refractory, and loss of the carbon as carbon monoxide gas or carbon dioxide gas. However, it is also believed that the known coatings provide inadequate protection at lower temperatures, and therefore significant low temperature carbon burnout occurs when using known coatings. It is believed that the phosphate frit allows the composition to soften at a lower temperature, providing improved coverage of the refractory and improved protection from carbon burnout at lower temperatures (e.g. 500-800° C.). This is demonstrated in FIGS. 1 to 9, as discussed in further detail below.

Furthermore, when the coated refractory body is heated gradually from room temperature, a multi-layer refractory body coating as described above can provide improved protection from low-temperature carbon burnout relative to a single layer coating. This is because the top layer comprises a high phosphate frit content (e.g., greater 60 wt. %) which means the top layer softens and melts at lower temperatures (for example between 405 and 550° C.), forming an impenetrable top layer which oxygen cannot pass through. However, when the coated refractory body is heated more quickly, having merely a single layer coating (as described above) may provide protection from low-temperature carbon burnout.

The example compositions described herein therefore provide a refractory coating that prevents both high and low temperature carbon burnout.

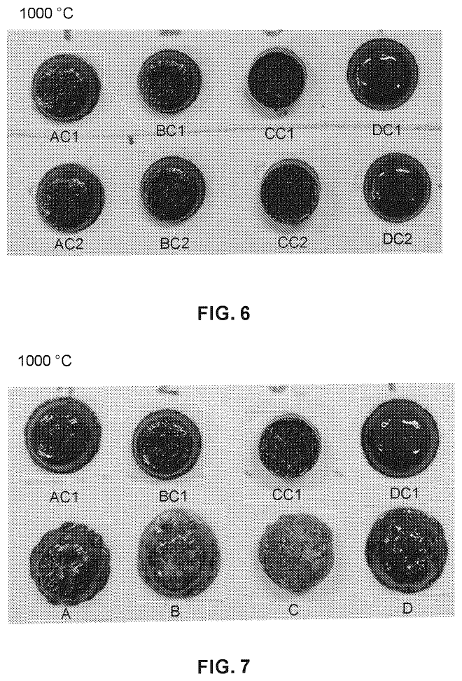

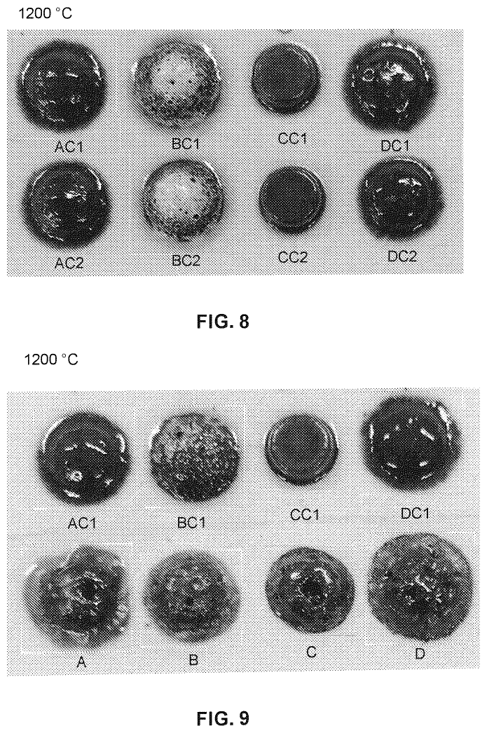

FIGS. 1 to 9 are photographs illustrating the results of a test on the example coatings A, B, C, and D, and the corresponding comparative example coatings of Table 1. The test involved heating samples of the example compositions and comparative example compositions of Table 1 to various temperatures, and observing the softening behavior of the samples. The samples were heated to 500° C. for 4 hours (FIG. 1), 600° C. for 4 hours (FIGS. 2 & 3), 700° C. for 4 hours (FIGS. 4 & 5), 1000° C. for 4 hours (FIGS. 6 & 7), and 1200° C. for 4 hours (FIGS. 8 & 9). Example compositions A, B, C, and D and the first set of comparative examples AC1, BC1, CC1, and DC1 are shown in FIGS. 1, 3, 5, 7, and 9. The first set of comparative examples AC1, BC1, CC1, and DC1 and the second set of comparative examples AC2, BC2, CC2, and DC2 are shown in FIGS. 2, 4, 6, and 8. It can be seen in FIGS. 1 to 9 that the example frits A, B, C, and D comprising the phosphate frit soften at lower temperatures (700-1000° C.) relative to the comparative examples, and provide improved coverage of the substrate. This indicates an improved performance for the phosphorous frit containing compositions within this temperature range, for the reasons described in the paragraph above. It has also been found that phosphate frits provide improved performance relative to phosphorus salts (such as a sodium phosphate).

The glass frit of the composition acts to form a continuous layer of material over the surface of the refractory substrate. In the examples of Table 1, the glass frit comprises a silicate frit. The composition may comprise up to 70 wt. % of the glass frit, such as 5 to 70 wt. % of the glass frit. In some examples, such as when the composition is used as a single layer coating or the main layer in a multi-layer coating, the composition may comprise 40 to 70 wt. % of the glass frit. Preferably, in these examples, the composition may comprise 45 to 65 wt. % of the glass frit. Most preferably, in these examples the composition may comprise 50 to 60 wt. % of the glass frit. In some examples, such as when the composition is used as the top layer in a multi-layer coating, the composition may comprise up to 20 wt. % of the glass frit, such as 5 to 20 wt. %. The composition may comprise 5 to 15 wt. % of the glass frit. In of the example where the composition is used as the top layer in a multi-layer coating, the composition may be substantially free of (silicate) glass frit that is different from the phosphate frit.

In some examples, the glass frit comprises a single frit, such as a single borosilicate frit (i.e., a frit comprising boron oxide and silicon oxide). The borosilicate frit may comprise at least 10 wt. % boron oxide and at least 10 wt. % silicon oxide. The borosilicate frit may be substantially phosphorous-free. Preferably, the borosilicate frit comprises 15 to 40 wt. % boron oxide, such as 30 wt. % boron oxide. Preferably, the borosilicate frit comprises 20 to 50 wt. % silicon oxide, such as 35 wt. % silicon oxide. The borosilicate frit may comprise 5 to 25 wt. % aluminum oxide, such as 13 wt. % aluminum oxide. The borosilicate frit may comprise 10 to 35 wt. % of alkali metal oxides and/or alkaline earth metal oxides, such as 15 wt. % sodium oxide, 4 wt. % potassium oxide and 3 wt. % calcium oxide. The borosilicate frit may comprise up to 3 wt. % zirconium oxide, such as 0.7 wt. % zirconium oxide. An example borosilicate frit includes 12.88 wt. % of Al₂O₃, 29.66 wt. % of B₂O₃, 2.62 wt. % of CaO, 3.99 wt. % of K₂O, 15.00 wt. % of Na₂O, 35.15 wt. % of SiO₂ and 0.70 wt. % of ZrO₂.

In other examples, the glass frit comprises two or more different frits. The glass frit may comprise a first borosilicate frit and a different second cobalt-containing borosilicate frit. For instance, the glass frit of the examples A-D of Table 1 comprises a first borosilicate frit and a different second cobalt-containing borosilicate frit. The first borosilicate frit and the second cobalt-containing borosilicate frit are a zircon frit and a blue cobalt frit respectively in the examples of Table 1. An example zircon frit used in the examples of Table 1 comprises 12.88 wt. % of Al₂O₃, 29.66 wt. % of B₂O₃, 2.62 wt. % of CaO, 3.99 wt. % of K₂O, 15.00 wt. % of Na₂O, 35.15 wt. % of SiO₂ and 0.70 wt. % of ZrO₂. The first borosilicate frit may be substantially cobalt-free. The first borosilicate frit may be substantially phosphorous-free. An example blue cobalt frit used in the examples of Table 1 comprises 15.30 wt. % of Al₂O₃, 26.30 wt. % of B₂O₃, 4.90 wt. % of CoO, 4.30 wt. % of K₂O, 0.50 wt. % of MnO, 12.70 wt. % of Na₂O, and 36.00 wt. % of SiO₂. The second borosilicate frit may be substantially phosphorous-free.

The first borosilicate frit may be a zircon frit and comprise zirconium oxide. The second cobalt-containing borosilicate frit may be a blue cobalt frit and comprise cobalt oxide. The first borosilicate frit and the second cobalt-containing borosilicate frit may each comprise at least 10 wt. % boron oxide and at least 10 wt. % silicon oxide. Preferably, the first borosilicate frit and the second cobalt-containing borosilicate frit may each comprise 15 to 40 wt. % boron oxide. The first borosilicate frit and the second cobalt-containing borosilicate frit may each comprise 20 to 50 wt. % silicon oxide. The first borosilicate frit and the second cobalt-containing borosilicate frit may each comprise 5 to 25 wt. % aluminum oxide. The first borosilicate frit and the second cobalt-containing borosilicate frit may each comprise 10 to 35 wt. % of alkali metal oxides and/or alkaline earth metal oxides.

In some examples, the composition comprises up to 50 wt. % of the first borosilicate frit and up to 20 wt. % of the second borosilicate frit, such as 5 to 50 wt. % of the first borosilicate frit and 1 to 20 wt. % of the second borosilicate frit. In some examples, such as when the composition is used as a single layer coating or the main layer in a multi-layer coating, the composition comprises 30 to 50 wt. % of the first borosilicate frit and to 20 wt. % of the second cobalt-containing borosilicate frit. Preferably, in these examples, the composition comprises 35 to 45 wt. % of the first borosilicate frit and 12 to 17 wt. % of the second cobalt-containing borosilicate frit. For instance, example composition D of Table 1 comprises 40 wt. % of the example zircon frit described in the paragraph above, and 15 wt. % of the example blue cobalt frit described in the paragraph above. In some examples, such as when the composition is used as the top layer in a multi-layer coating, the composition comprises up to 15 wt. % of the first borosilicate frit and up to 10 wt. % of the second borosilicate frit. In these examples, the composition may comprise 2 to 10 wt. % of the first borosilicate frit and 1 to 5 wt. % of the second borosilicate frit.

In other examples, the glass frit may comprise a borosilicate frit and a boron-free silicate frit. The borosilicate frit may be a zircon frit. The boron-free silicate frit may comprise at least 50 wt. % silicon oxide. Preferably, the boron-free silicate frit comprises 50 to 65 wt. % silicon oxide, such as 59 wt. % silicon oxide. The boron-free silicate frit may comprise 25 to 50 wt. % of alkali metal oxides and/or alkaline earth metal oxides, such as 17 wt. % sodium oxide, 13 wt. % potassium oxide, 3 wt. % lithium oxide and 3 wt. % calcium oxide. The boron-free silicate frit may comprise 2 to 5 wt. % of cobalt oxide, such as 4 wt. % cobalt oxide. The boron-free silicate frit may comprise up to 2 wt. % of aluminum oxide, such as 0.5 wt. % of aluminum oxide. The boron-free silicate frit may comprise up to 3 wt. % of fluorine, such as 1 wt. % fluorine. An example boron-free silicate frit includes 0.53 wt. % of Al₂O₃, 4.04 wt. % of Co₂O₃, 2.87 wt. % of CaO, 12.60 wt. % of K₂O, 2.65 wt. % of Li₂O, 17.08 wt. % of Na₂O, 58.90 wt. % of SiO₂ and 1.32 wt. % of F. The boron-free silicate frit may be substantially boron-free. The boron-free silicate frit may be substantially phosphate-free. For instance, the glass frit of examples E and F of Table 1 comprise a first zircon frit and a boron-free (cobalt) silicate frit. The boron-free silicate frit may also be used as a single frit.

In some examples, the composition comprises up to 50 wt. % of the borosilicate frit and up to 20 wt. % of the boron-free silicate frit, such as 5 to 50 wt. % of the borosilicate frit and 1 to 20 wt. % of the boron-free silicate frit. In some examples, such as when the composition is used as a single layer coating or the main layer in a multi-layer coating, the composition comprises 30 to 50 wt. % of the borosilicate frit and 10 to 20 wt. % of the boron-free silicate frit. For instance, example composition E of Table 1 comprises 35 wt. % of the example zircon frit described above, and 15 wt. % of the example boron-free silicate frit described above. In some examples, such as when the composition is used as the top layer in a multi-layer coating the composition comprises up to 15 wt. % of the borosilicate frit and up to 10 wt. % of the boron-free silicate frit. In these examples, the composition may comprise 2 to 10 wt. % of the borosilicate frit and 1 to 5 wt. % of the boron-free silicate frit. For instance, example composition F of Table 1 comprises 8 wt. % of the example zircon frit described above, and 3 wt. % of the example boron-free silicate frit described above.

In some examples, the composition comprises up to 50 wt. % of the oxidizable component, such as 2 to 50 wt. % of the oxidizable component. In some examples, such as when the composition is used as a single layer coating or the main layer in a multi-layer coating, the composition may comprise 25 to 40 wt. % of the oxidizable component. In some examples, such as when the composition is used as the top layer in a multi-layer coating, the composition may comprise 2 to 15 wt. % of the oxidizable component. Preferably, in these examples, the composition may comprise 5 to 10 wt. % of the oxidizable component. The oxidizable component acts as a sacrificial part of the coating, by reacting with any oxygen in the proximity of the refractory. The oxidizable component may oxidize at 800 to 1200° C. in air at atmospheric pressure. The oxidizable component can also be considered as an oxygen scavenger or an antioxidant.

In some examples, the oxidizable component comprises a metal, a metalloid, and/or a carbide. The metal or metalloid could for example be silicon metal or molybdenum metal. The carbide could for example be silicon carbide. In some examples, the composition may comprise up to 40 wt. % of the metal or metalloid, such as 2 to 40 wt. % of the metal or metalloid. In some examples, such as when the composition is used as a single layer coating or the main layer in a multi-layer coating, the composition may comprise 10 to 35 wt. % of the metal or metalloid. Preferably, in these examples, the composition comprises 15 to 25 wt. % of the metal or metalloid. Most preferably, in these examples, the composition comprises 17 to 23 wt. % of the metal or metalloid. In some examples, such as when the composition is used as the top layer in a multi-layer coating, the composition may comprise up to 10 wt. % of the metal or metalloid, such as 2 to 10 wt. % of the metal or metalloid. Preferably, in these examples, the composition may comprise 2 to 5 wt. % of the metal or metalloid. In some examples, the composition comprises up to 20 wt. % of the carbide, such as 1 to 15 wt. % of the carbide. In some examples, such as when the composition is used as a single layer coating or the main layer in a multi-layer coating, the composition may comprise 5 to 15 wt. % of the carbide. Preferably, in these examples, the composition comprises 7 to 13 wt. % of the carbide. In some examples, such as when the composition is used as the top layer in a multi-layer coating, the composition may comprise 1 to 15 wt. % of the carbide. Preferably, in these examples, the composition may comprise 1 to 12 wt. % of the carbide.

In examples A, B and D of Table 1, the oxidizable component comprises a metal and a carbide. More specifically, the metal or metalloid of examples A, B, D, E and F of Table 1 is silicon metal, and the carbide is silicon carbide. In example C of Table 1, the oxidizable component is a metal or metalloid, and more specifically silicon metal. In example G of Table 1, the oxidizable component is a carbide, and more specifically silicon carbide.

In some examples, the composition further comprises a refractory component. The refractory component can improve the heat resistance of the coating. The refractory component may comprise a clay and/or a refractory oxide. The clay may comprise for example ball clay, as in examples A, B, C, D, E and F of Table 1, or alternatively bentonite clay, as in examples F and G. The refractory oxide may comprise feldspar or quartz. In some examples, the composition comprises up to 20 wt. % of the refractory component, such as 2 to 30 wt. % of the refractory component. Preferably, the composition comprises 5 to 20 wt. % of the refractory component. Most preferably, the composition comprises 8 to 15 wt. % of the refractory component.

The composition is substantially aluminum metal free, i.e., the composition comprises substantially no aluminum metal and no aluminum alloys. The composition may comprise less than 0.5 wt. % of aluminum metal or aluminum alloy. Preferably, the composition comprises less than 0.3 wt. % of aluminum metal or aluminum alloy. Most preferably, the composition comprises less than 0.1 wt. % of aluminum metal or aluminum alloy. In some examples, the composition is aluminum metal free, i.e., comprises no aluminum or aluminum alloy.

In some examples, the composition includes less than 5 wt. % of organic material. Preferably, the composition comprises less than 1 wt. % of organic material. Most preferably, the composition is substantially free of organic material, and may comprise less than 0.1 wt. % of organic material.

The phosphate frit is different from the glass frit, i.e., the phosphate frit has a different chemical composition to the one or more glass frits of the glass frit. The composition may comprise up to 90 wt. % of the phosphate frit, such as 2 to 90 wt. % of the phosphate frit. In some examples, such as when the composition is used as a single layer coating or the main layer in a multi-layer coating, the composition may comprise 2 to 9 wt. % of the phosphate frit. Preferably, in these examples, the composition comprises 3 to 8 wt. % of the phosphate frit, such as 5 wt. % or 6 wt. %. In some examples, such as when the composition is used as the top layer in a multi-layer coating, the composition may comprise 60 to 90 wt. % of the phosphate frit. Preferably, in these examples, the composition may comprise 70 to 90 wt. % of the phosphate frit.

Table 2 below shows some example phosphate frits. Example phosphate frit 2 of Table 2 is the phosphate frit used in examples A-G of Table 1.

TABLE 2

| | Phosphate | Phosphate | Phosphate | Phosphate |
|---|---|---|---|---|
| | frit | frit | frit | frit |
| Example | 1 / wt. % | 2 / wt. % | 3 / wt. % | 4 / wt. % |
| Al₂O₃ | 18.0 | 22.8 | 4.4 | 18.6 |
| K₂O | 14.1 | 14.1 | 0 | 14.6 |
| B₂O₃ | 2.5 | 0 | 0 | 2.6 |
| Na₂O | 12.2 | 11.4 | 23.9 | 17.1 |
| F | 7.5 | 7.0 | 0 | 0 |
| P₂O₅ | 41.5 | 40.6 | 54.7 | 42.9 |
| Li₂O | 4.2 | 4.2 | 0 | 4.3 |
| MgO | 0 | 0 | 3.4 | 0 |
| SrO | 0 | 0 | 8.9 | 0 |
| CaO | 0 | 0 | 4.8 | 0 |

In some examples, the phosphate frit comprises up to 50 wt. % of aluminum oxide. Preferably, the phosphate frit comprises 1 to 40 wt. % of aluminum oxide. Most preferably, the phosphate frit comprises 15 to 25 wt. % of aluminum oxide.

In some examples, the phosphate frit comprises 0-5 wt. % of boron oxide. Some of the example phosphate frits are substantially boron-free (such as frits 2 and 3 of Table 2). These low boron or substantially boron-free phosphate frits could have advantages where the use of boron is discouraged, for instance in nuclear applications. In some examples, the phosphate frit may contain less than 0.3 wt. % boron oxide, or preferably less than 0.1 wt. % boron oxide. In some examples, the phosphate frits are boron-free, i.e., comprise no boron. Where the phosphate frit comprises boron oxide, in some examples the phosphate frit comprises up to 6% by weight of boron oxide, such as 1 to 5% by weight boron oxide.

The phosphate frit comprises phosphorous oxide. In some examples, the phosphate frit comprises up to 70 wt. % phosphorous oxide, and may comprise 30 to 65 wt. % of phosphorous oxide. Preferably, the phosphate frit comprises 35 to 60 wt. % of phosphorous oxide. Most preferably, the frit comprises 35 to 50 wt. % of phosphorous oxide.

In the examples of Table 2, the phosphate frits each include at least one further metal oxide. In some examples, the at least one further metal oxide is an alkali metal oxide. The at least one further metal oxide may include one, two, three, or more alkali metal oxides. Where the at least one further metal oxide comprises one or more alkali metal oxides, the one or more alkali metal oxides may comprise at least one of: sodium oxide, potassium oxide, or lithium oxide. In some examples, the phosphate frit comprises 10 to 50 wt. % of alkali metal oxides.

Where the phosphate frit comprises sodium oxide, in some examples the phosphate frit comprises 5 to 35 wt. % of sodium oxide. Preferably, the phosphate frit comprises to 25 wt. % of sodium oxide. Most preferably, the phosphate frit comprises 7 to 14 wt. % of sodium oxide. Where the phosphate frit comprises potassium oxide, in some examples the phosphate frit comprises 5 to 20 wt. % of potassium oxide. Preferably, the phosphate frit comprises 11 to 20 wt. % of potassium oxide. Where the phosphate frit comprises lithium oxide, in some examples the phosphate frit comprises up to 10 wt. % of lithium oxide, and may comprise 0.5 to 10 wt. % of lithium oxide. Preferably, the phosphate frit comprises 3 to 8.5 wt. % of lithium oxide.

In some examples, the phosphate frit further comprises at least one alkaline earth oxide. Where the phosphate frit comprises at least one alkaline earth oxide, the at least one alkaline earth oxide includes at least one of: barium oxide, calcium oxide or magnesium oxide. Where the phosphate frit comprises calcium oxide, in some examples the phosphate frit comprises 2 to 8 wt. % of calcium oxide. Where the phosphate frit comprises magnesium oxide, in some examples the phosphate frit comprises 1 to 6 wt. % of magnesium oxide.

In some examples, the phosphate frit is substantially silicon oxide free. In some examples, the phosphate frit may contain less than 0.3 wt. % silicon oxide, or preferably less than 0.3 wt. % silicon oxide. In some examples, the phosphate frit is silicon oxide free, i.e., comprises no silicon oxide.

In some examples, the phosphate frit further comprises strontium oxide. Where the phosphate frit comprises strontium oxide, in some examples the phosphate frit comprises 5 to 14 wt. % of strontium oxide.

In some examples, the phosphate frit is an oxide frit comprising oxide ions. In some examples, the phosphate frit is a mixed oxide-halide frit, with the phosphate frit including both halide and oxide ions. Halide ions are unable to bridge between two positive ions, unlike oxide ions, and thus provide for a phosphate frit with a lower softening point when halide ions replace some oxide ions in the phosphate frit.

In the examples of frits 1 and 2, the phosphate frit is a mixed oxide-fluoride frit. Where the phosphate frit comprises fluoride, in some examples the phosphate frit comprises 1 to 13 wt. % of fluoride. Preferably, the phosphate frit comprises 4.5 to 9.5 wt. % of fluoride.

In some examples, the phosphate frit is ground to form a powder, for example by wet or dry ball milling, to an average particle size of less than 75 μm. In some examples, the phosphate frit is graded, for example by using a sieve or mesh, to an average particle size of 0.1 to 0.4 mm.

The phosphate frits described above may be formed by heating a mixture including: the chemical elements contained in the phosphate frit in elemental form, and/or compounds containing the elements. The compounds containing the elements could be metal oxides (e.g. sodium oxide) or metal salts (e.g. sodium carbonate). An example mixture is shown in Table 3 below.

The components of the mixture can for instance be heated in a continuous or batch furnace, with the heat being provided by gas flame or electricity. The mixture may be heated until the components are melted. The components can be left in the furnace to dwell for a predetermined time period, to allow the components to mix homogenously.

Once heated, the mixture is cooled. The mixture may be cooled by quenching to an amorphous glassy state. The quenching includes rapid cooling, for instance using water-cooled metal rollers, to produce a flake or granulate material. The flake or granulate material may be crushed prior to milling.

The phosphate frits can then be milled into particle form, for example by ball milling.

| Components of | Compounds in the mixture | wt. % of component |
|---|---|---|
| phosphate frit | used to form phosphate | in phosphate frit |
| 2 of Table 2 | frit 2 of Table 2 | 2 of Table 2 |
| Al₂O₃ | Aluminum phosphate | 22.8 |
| | and/or alumina | |
| K₂O | Potassium carbonate | 14.1 |
| Na₂O | Sodium fluoride | 11.4 |
| P₂O₅ | Aluminum phosphate | 40.6 |
| Li₂O | Lithium carbonate | 4.2 |
| F | Sodium fluoride | 7.0 |

Once the components of the composition (including the glass frit, the oxidizable component, and the phosphate frit) are available, the components of the composition are physically mixed together in an aggregate. The components of the coating/glaze composition may each be in a powder form. The components of the composition may be mixed together in a ball mill.

### Slurry

In some examples, one of the compositions described herein may be suspended in a liquid to provide a slurry for coating a refractory body. The composition may be for instance the example compositions A-G of Table 1. The liquid of the slurry may be water.

In some examples, the slurry comprises 70-80 wt. % of the composition, and 20-30 wt. % of water.

The slurry may further comprise a thickener, such as 0.3-4 wt. % of thickener. The thickener could for instance be an organic gum-based thickener, such as Peptapon. The slurry may further comprise a dispersant, such as 0.1-1 wt. % of dispersant. The dispersant could for instance be a polymeric dispersing agent, such as Dispex®.

A slurry according to examples of the disclosure may be formed by mechanically dispersing the composition into water, for example using a high shear mixer.

### Coated Refractory Body

Examples of the disclosure also provide a refractory body comprising a coating of the composition described herein.

In some examples, the coating has an area density of 1 to 2000 mg/cm². Preferably, the coating has an area density of 10 to 500 mg/cm². Most preferably, the coating has an area density of 50 to 100 mg/cm², such as 82 mg/cm².

In some examples, the refractory body comprises a single coating of the composition described herein, as explained above. In other examples, the refractory body comprises multiple coatings of the composition, such as two coatings, as explained above.

The refractory body may be made from a carbon-based material, such as magnesia-carbon (MgO—C), alumina-carbon (Al₂O₃—C), zirconia-carbon (ZrO₂—C), or graphite. The refractory body may be for a continuous metal casting system. The refractory body could be for instance an entry nozzle, a pouring nozzle, a ladle shroud or a monoblock stopper.

### Method of Applying the Coating

Examples of the disclosure also provide a method of applying the composition described herein to a refractory body. The method comprises applying the slurry described herein to the refractory body. The slurry may be applied to the refractory body by dipping, flooding, spraying or painting.

The slurry can then be left to dry, to leave a coating of the composition on the refractory body. In some examples, once the slurry has dried, more of the slurry is applied to the refractory body, to provide a further coating of the composition on the refractory body.

The refractory body may be fired in a furnace once the coating (and further coating in some examples) has been applied, preferably after the slurry has dried. The refractory body may be fired in the furnace at between 1100° C. and 1300° C. for a number of hours, for instance at 1200° C. for four hours. Alternatively, the refractory body is wrapped with packaging once the coating (and further coating in some examples) has been applied, preferably after the slurry has dried. The wrapped refractory body can be fired at a later time or date, for example after transportation.

There is thus described a composition for coating a refractory body, a slurry, a coated refractory body, a method of applying the composition to the refractory body and a refractory body coating with a number of advantages as detailed above and as follows. The composition provides enhanced protection from oxidation for a carbon-based refractory body, at both low temperatures and high temperatures. The composition thus can improve the lifetime of carbon-based refractory bodies.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims. The phosphate frit could be used in a wide variety of refractory coatings. As described previously, known refractory coatings provide protection from carbon burnout at higher temperatures (e.g. over 800° C.), but the phosphate frit provides additional protection from carbon burnout at lower temperatures (e.g. 440-800° C.). The phosphate frit can therefore improve a wide variety of refractory coatings. For instance, a variety of frits could be used in the glass frit, or alternative oxidizable components could be used.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasize an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the applicant may seek protection via the claims in respect of any patentable feature or combination of features hereinbefore referred to and/or shown in the drawings whether or not emphasis has been placed thereon.

1. A composition for coating a refractory body, the composition comprising:
an oxidizable component; and
a phosphate frit comprising phosphorous oxide,
wherein the composition is substantially aluminum metal free.

2. The composition of claim 1, wherein the composition comprises up to 90 wt. % of the phosphate frit.

3. The composition of claim 1, wherein the composition comprises 2 to 90 wt. % of the phosphate frit.

4. The composition of claim 1, wherein the composition comprises 2 to 9 wt. % of the phosphate frit.

5. The composition of claim 1, wherein the composition comprises 60 to 90 wt. % of the phosphate frit.

6. The composition of claim 1, wherein the phosphate frit comprises 30 to 70 wt. % of phosphorous oxide.

7. The composition of claim 1, wherein the phosphate frit comprises up to 50 wt. % aluminum oxide.

8. The composition of claim 1, wherein the phosphate frit is substantially free of silicon oxide.

9. The composition of claim 1, wherein the phosphate frit comprises 5 to 35 wt. % sodium oxide.

10. The composition of claim 1, wherein the phosphate frit comprises 0-5 wt. % of boron oxide.

11. The composition of claim 1, wherein the composition comprises a glass frit, different from the phosphate frit.

12. The composition of claim 11, wherein the composition comprises to 70 wt. % of the glass frit.

13. The composition of claim 11, wherein the glass frit comprises a silicate frit.

14. The composition of claim 11, wherein the silicate glass frit comprises a borosilicate frit.

15. (canceled)

16. (canceled)

17. The composition of claim 14, wherein the glass frit comprises the borosilicate frit and a different, cobalt-containing, borosilicate frit.

18. The composition of claim 17, wherein the composition comprises to 50 wt. % of the borosilicate frit and 10 to 20 wt. % of the different, cobalt-containing, borosilicate frit.

19-22. (canceled)

23. The composition of claim 1, wherein the oxidizable component comprises a metal or metalloid.

24. (canceled)

25. The composition of claim 23, wherein the metal or metalloid comprises silicon metalloid.

26. The composition of claim 1, wherein the oxidizable component comprises a carbide.

27-33. (canceled)

34. A refractory body coating comprising:
an oxidizable component; and
a phosphate frit comprising phosphorous oxide,
wherein the coating is substantially aluminum metal free.

35-42. (canceled)
